(19) United States
(12) Patent Application Publication
(10) Pub. No.: US 2011/0221792 A1
(43) Pub. Date: Sep. 15, 2011

(54) LIQUID CRYSTAL DEVICE, METHOD OF DRIVING THE SAME, AND ELECTRONIC APPLIANCE

(75) Inventors: Kazuyuki Maeda, Aichi (JP); Norio Koma, Gifu (JP); Masashi Mitsui, Miyagi (JP); Kenji Tanase, Gifu (JP); Yoshihiro Watanabe, Kanagawa (JP)

(73) Assignee: SONY CORPORATION, Tokyo (JP)

(21) Appl. No.: 13/042,551

(22) Filed: Mar. 8, 2011

(30) Foreign Application Priority Data
Mar. 9, 2010 (JP) P2010-051527

(51) Int. Cl. G09G 5/10

(52) U.S. Cl. 345/690

(57) ABSTRACT

A liquid crystal device includes: a pixel for outputting a specified color light, which is provided with liquid crystals and an electrode for driving the liquid crystals and outputs light of the specified color; a pixel for controlling luminance and color purity, which outputs a control light for controlling the luminance and the color purity of the output light of the specified color; and a driving unit driving the pixel for outputting a specified color light, and the pixel for controlling luminance and color purity based on brightness information that indicates the brightness of an external environmental light.

### CROSS REFERENCES TO RELATED APPLICATIONS

The present application claims priority to Japanese Priority Patent Application JP 2010-051527 filed in the Japan Patent Office on Mar. 9, 2010, the entire contents of which is hereby incorporated by reference.

### BACKGROUND

The present application relates to a liquid crystal device, a method of driving the same, and an electronic appliance.

As a reflective liquid crystal device, a liquid crystal display has been proposed to perform a display through so-called four-color sub-pixels, for example, by adding white (W) sub-pixels to sub-pixels that express three primary colors of red (R), green (G), and blue (B) (for example, see JP-A-2000-330102). According to this liquid crystal device, a displayable range of luminance is widened through addition of the white (W) sub-pixels, and thus a bright image can be obtained. Also, even in a so-called semi-transmissive reflective liquid crystal device having both a reflective mode and a transmissive mode, addition of white (W) sub-pixels as described above has been proposed (for example, see JP-A-2007-183569 and JP-A-2008-64945).

### SUMMARY

Since the liquid crystal device described in JP-A-2000-330102 is a reflective liquid crystal device, and has the problem that its display has a tendency to become dark, it is preferable that the display becomes bright when the liquid crystal device is used in a dark place. However, by contrast, if the white (W) sub-pixels are added, the color purity deteriorates, and particularly in the case where the liquid crystal device is used in a bright place, a vivid color display may not be obtained. Also, the semi-transmissive reflective liquid crystal device described in JP-A-2007-183569 and JP-A-2008-64945 and further a transmissive liquid crystal device have the same problem. Accordingly, there is a need for achieving a balance between a bright display in a dark place and a vivid color display in a bright place.

In view of the above situation, it is desirable to provide a liquid crystal device that can present a bright display and a vivid color display in accordance with the brightness of an external environment, a method of driving the liquid crystal device, and an electronic appliance that can perform such a display.

According to an embodiment, there is provided a liquid crystal device including: a pixel for outputting a specified color light, which is provided with liquid crystals and an electrode for driving the liquid crystals and outputs light of the specified color; a pixel for controlling luminance and color purity, which outputs a control light for controlling the luminance and the color purity of the output light of the specified color; and a driving unit driving the pixel for outputting a specified color light, and the pixel for controlling luminance and color purity based on brightness information that indicates the brightness of an external environmental light. Further, the pixel for outputting a specified color light may include a sub-pixel for outputting a red light, a sub-pixel for outputting a green light, and a sub-pixel for outputting a blue light, and the pixel for controlling luminance and color purity may include a pixel for controlling luminance and color purity, which outputs the control light for controlling the luminance and the color purity of at least one output light of the red color, the green color, and the blue color.

According to the liquid crystal device according to the embodiment, the driving unit is configured to generate a driving signal that is supplied to the pixel for controlling luminance and color purity based on the brightness information of the external environmental light, and for example, in the case of using the liquid crystal device according to the embodiment in a bright place, the driving signal, which lowers the light transmission of the liquid crystals in comparison to a case where the liquid crystal device is used in a dark place, can be generated and supplied with respect to the pixel for controlling luminance and color purity. In this case, the output light from the pixel for controlling luminance and color purity is reduced to lower the brightness of the display, whereas the ratio of a specified color (red light, green light, or blue light) forming part of the whole output light is relatively increased to improve the color purity. On the contrary, even in the case of using the liquid crystal device in the bright place, the driving signal, which increases the light transmission of the liquid crystals in comparison to a case where the liquid crystal device is used in the dark place, can be generated and supplied. In this case, the color purity deteriorates, but the brightness is improved. By doing this, a liquid crystal device, which can perform any one of a bright display and a vivid color display in accordance with the brightness of the external environmental light, is realized.

In the case where the liquid crystal device according to the embodiment is a reflective liquid crystal device that forms an image by a reflected light from a reflection layer that is installed on one of a pair of substrates, it is preferable that the driving unit drives the pixel for controlling luminance and color purity so that the luminance of the control light from the pixel for controlling luminance and color purity becomes higher when the external environmental light is dark rather than bright.

Since the reflective liquid crystal device performs a display using an external light, it is characterized that a display becomes bright in a bright place, and the display becomes dark in a dark place. Accordingly, a vivid color display is required in a bright place, and a bright display is required in a dark place. In this point, according to the above-described configuration, since the driving signal is controlled and driven so that the luminance of the control light from the pixel for controlling luminance and color purity becomes higher when the external environmental light is dark rather than bright, the vivid color display is performed in a bright place, and a bright display is performed in a dark place.

In the case where the liquid crystal device according to the embodiment is a transmissive liquid crystal device that forms the image by a transmissive light from an illumination device that is installed on the outside of the pair of substrate, it is preferable that the driving unit drives the pixel for controlling luminance and color purity so that the luminance of the control light from the pixel for controlling luminance and color purity becomes lower when the external environmental light is dark rather than bright.

Since the transmissive liquid crystal device performs a display using light from an illumination device, that is, using light from a light source provided in the liquid crystal device itself, it is difficult to visually recognize the display in a bright place, but it is rather easy to visually recognize the display in a dark place. Because of this, unlike the reflective liquid crystal display device, a bright display is necessary in the bright place, while a vivid color display is necessary in the dark place. On this point, according to the above-described configuration, when the external environmental light is dark rather than bright, the driving signal is controlled so that the luminance of the control light from the pixel for controlling luminance and color purity is lowered, and thus a brighter display in the bright place and a vivid color display in the dark place can be realized.

In the liquid crystal device according to the embodiment, a sensor that detects the brightness of the external environment may be provided, and the driving unit may drive the pixel for controlling luminance and color purity based on the brightness information detected by the sensor.

That is, the above-described brightness information may be input from the outside of the liquid crystal device according to the embodiment, or may be obtained from a sensor provided in the liquid crystal device according to the embodiment. In the former case, it is not necessary for the liquid crystal device itself to be provided with the brightness sensor, while in the latter case, the brightness sensor is not provided outside, but is provided inside the liquid crystal device to obtain the effect of the present application.

In the liquid crystal device according to the embodiment, the pixel for controlling luminance and color purity may be composed of a pixel for outputting a white light.

According to this configuration, one pixel is configured to be composed of four sub-pixels including a sub-pixel for outputting a red light, a sub-pixel for outputting a green light, a sub-pixel for outputting a blue light, and a pixel for outputting a white light to realize the liquid crystal device that particularly attaches importance to the brightness of the display.

Also, in the liquid crystal device according to the embodiment, the pixel for controlling luminance and color purity may include at least one of a sub-pixel for outputting a low-color purity red light, which outputs a red light having a color purity that is lower than that of the red light that is output from the sub-pixel for outputting a red light, a sub-pixel for outputting a low-color purity green light, which outputs a green light having a color purity that is lower than that of a green light that is output from the sub-pixel for outputting a green light, and a sub-pixel for outputting a low-color purity blue light, which outputs a blue light having a color purity that is lower than that of the blue light that is output from the sub-pixel for outputting a blue light.

According to this configuration, one pixel is configured to be composed of four to six sub-pixels including a sub-pixel for outputting a red light, a sub-pixel for outputting a green light, a sub-pixel for outputting a blue light, and at least one of a sub-pixel for outputting a low-color purity red light, a sub-pixel for outputting a low-color purity green light, and a sub-pixel for outputting a low-color purity blue light to realize a liquid crystal device having superior color reproduction.

According to another embodiment, there is provided a method of driving a liquid crystal device including the steps of: generating a driving signal that is supplied to a pixel for outputting a specified color light based on an image signal; and generating a driving signal that is supplied to a pixel for controlling luminance and color purity based on brightness information of the image signal and an external environmental light.

According to the method of driving a liquid crystal device according to the embodiment, a driving signal that is supplied to the pixel for controlling luminance and color purity is generated based on the brightness information of the external environmental light, and for example, in the case of using the liquid crystal device according to the embodiment in a bright place, a driving signal, which lowers the light transmission of the liquid crystals in comparison to a case where the liquid crystal device is used in a dark place, can be generated and supplied with respect to the pixel for controlling luminance and color purity. In this case, the output light from the pixel for controlling luminance and color purity is reduced to lower the brightness of the display, whereas the ratio of a specified color (red light, green light, or blue light) forming part of the whole output light is relatively increased to improve the color purity. On the contrary, even in the case of using the liquid crystal device in the bright place, a driving signal, which increases the light transmission of the liquid crystals in comparison to a case where the liquid crystal device is used in the dark place, can be generated and supplied. In this case, the color purity deteriorates, but the brightness is improved. By doing this, a method of driving a liquid crystal device, which can perform any one of a bright display and a vivid color display in accordance with the brightness of the external environment, is realized.

According to still another embodiment, there is provided an electronic appliance provided with a liquid crystal device as described above.

According to the embodiments of the application, the liquid crystal device according to the embodiment is provided as a display unit, and thus an electronic appliance provided with a display that can perform a bright display or a clear color display in accordance with the brightness of an external environment can be realized.

Additional features and advantages are described herein, and will be apparent from the following Detailed Description and the figures.

### BRIEF DESCRIPTION OF THE FIGURES

FIGS. 1A and 1B are diagrams illustrating a schematic configuration of pixels and a driving IC of a liquid crystal device according to a first embodiment;

FIG. 2 is a diagram illustrating the relationship between brightness information of an external environment and the luminance of an output light of a sub-pixel for controlling luminance and color purity in a liquid crystal device according to the first embodiment;

FIG. 3 is a diagram illustrating an operation of a liquid crystal device according to the first embodiment;

FIG. 4 is a diagram illustrating an operation of a liquid crystal device in the related art;

FIGS. 5A and 5B are diagrams illustrating a modified example of a liquid crystal device according to the first embodiment;

FIG. 6 is a diagram illustrating a pixel configuration in a liquid crystal device according to the second embodiment;

FIG. 7 is a diagram illustrating the relationship between brightness information of an external environment and the luminance of an output light of a sub-pixel for controlling luminance and color purity in a liquid crystal device according to a third embodiment;

FIGS. 8A and 8B are views illustrating the whole configuration of a liquid crystal device according to an embodiment;

FIG. 9 is an equivalent circuit diagram of a liquid crystal device according to an embodiment; and

FIG. 10 is a perspective view illustrating an example of an electronic appliance according to an embodiment.

### DETAILED DESCRIPTION

Embodiments of the present application will be described below in detail with reference to the drawings.

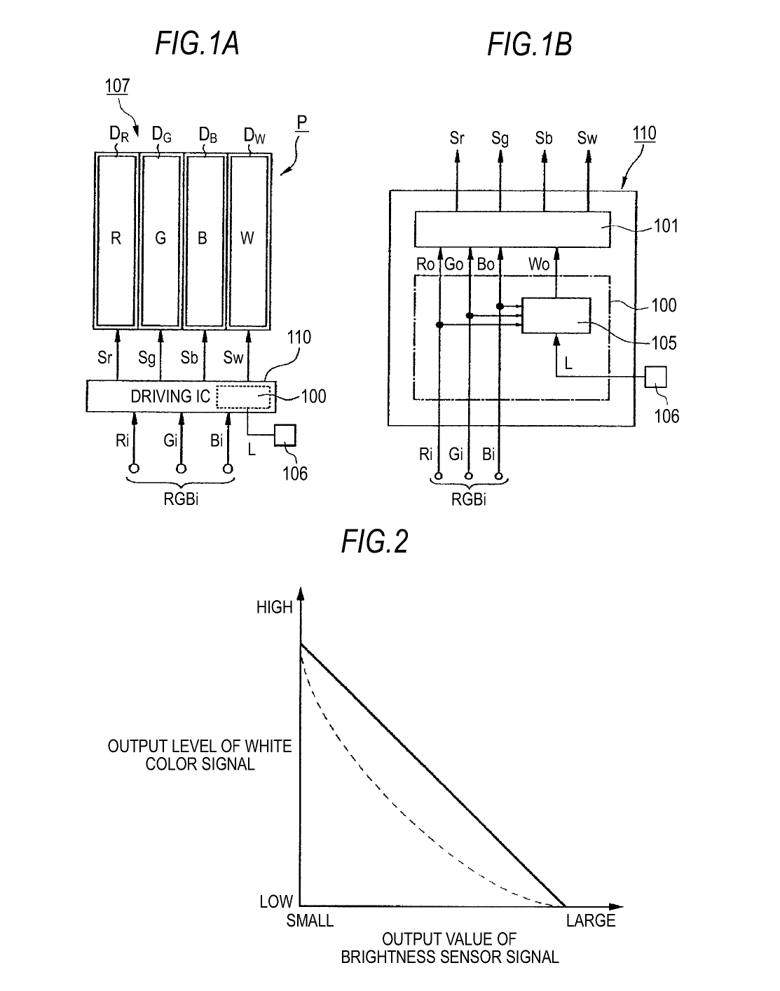

Hereinafter, a first embodiment will be described with reference to FIGS. 1A to 5B.

A liquid crystal device according to this embodiment is an example of a reflective liquid crystal device that uses a sub-pixel for outputting a white light (a pixel for outputting a white light) as a sub-pixel for controlling luminance and color purity (a pixel for controlling luminance and color purity) and a plurality of pixels for outputting specified color lights (a sub-pixel for outputting a red light, a sub-pixel for outputting a green light, and a sub-pixel for outputting a blue light) as pixels for outputting specified color lights.

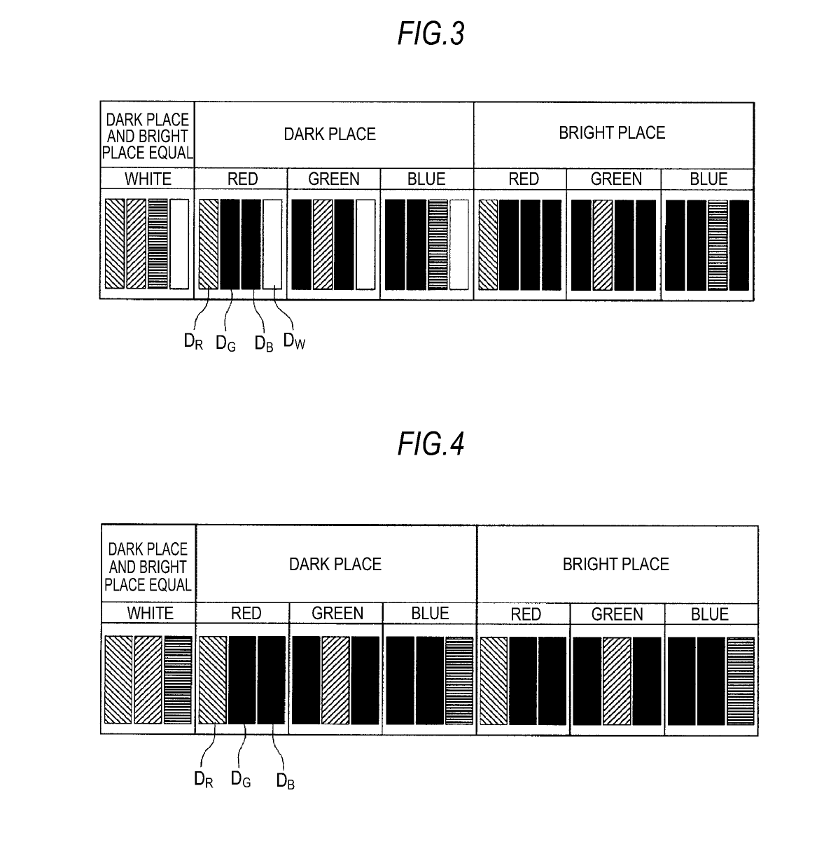

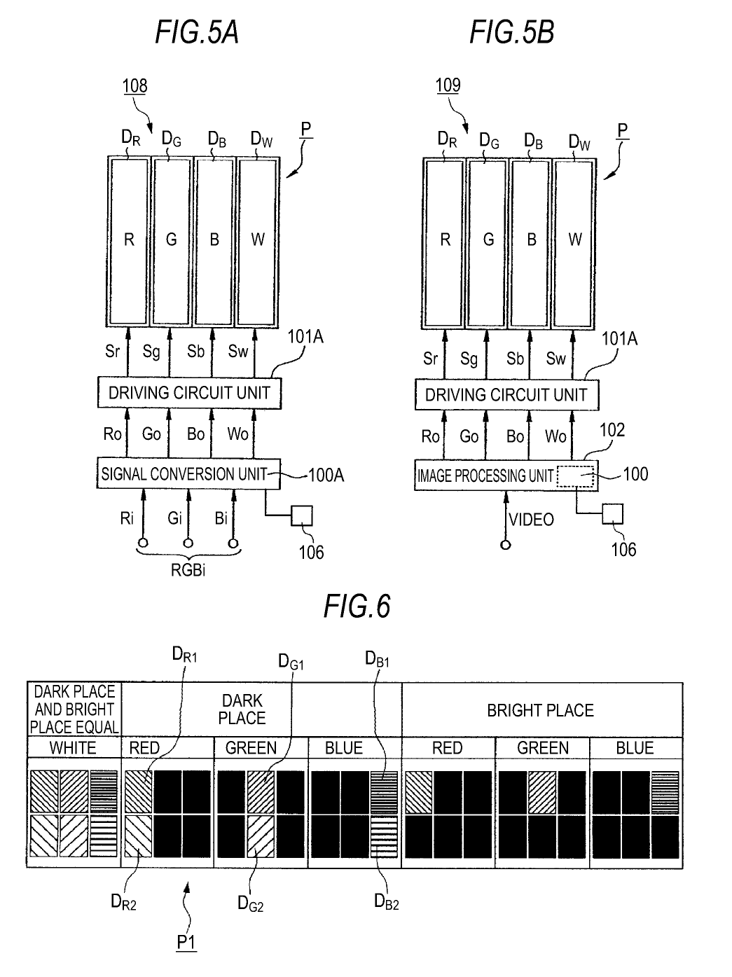

FIGS. 1A and 1B are diagrams illustrating a schematic configuration of pixels and a driving IC of a liquid crystal device according to the first embodiment. FIG. 2 is a diagram illustrating the relationship between brightness information of an external environment (external environmental light) and the luminance of an output light of a sub-pixel for outputting a white light. FIG. 3 is a diagram illustrating a display state of the liquid crystal device and FIG. 4 is a diagram illustrating a display state of a liquid crystal device in the related art. FIGS. 5A and 5B are diagrams illustrating a modified example of a liquid crystal device according to the first embodiment.

In all drawings hereinafter, each layer or each member has a different reduced scale in order to make each layer or each member have a size that is recognizable in the drawings.

In the respective embodiments of the application hereinafter, only a pixel configuration and a driving unit, which are primary units according to an embodiment, will be described, and the whole configuration of the liquid crystal device will be collectively described later.

A liquid crystal device 107 according to this embodiment, as illustrated in FIG. 1A, includes a pixel P that is composed of four-color sub-pixels including a sub-pixel D_{R} for outputting a red light, a sub-pixel D_{G} for outputting a green light, a sub-pixel D_{B} for outputting a blue light, and a sub-pixel D_{W} for outputting a white light (sub-pixel for controlling luminance and color purity), a driving IC (driving unit) 110 electrically connected to the pixel P, and a brightness sensor 106 detecting the brightness of an external environment in which the liquid crystal device is used. Among the four sub-pixels, the sub-pixel D_{W} for outputting a white light functions as a sub-pixel for controlling luminance and color purity. Since the ratio of the white light forming part of the whole output light becomes higher as the luminance of the output light from the sub-pixel D_{W} for outputting a white light becomes higher, the display becomes brighter with low color purity. On the contrary, since the ratio of the white light forming part of the whole output light becomes lower as the luminance of the output light from the sub-pixel D_{W} for outputting a white light becomes lower, the display becomes darker and has high color purity. As described above, by changing the luminance of the output light from the sub-pixel D_{W} for outputting the white light, the luminance and the color purity of the whole pixel can be controlled.

In this case, although only one pixel P is illustrated in FIG. 1A, a plurality of pixels are arranged in the form of a matrix in the whole liquid crystal device to form an image display unit to be described later.

The driving IC 110, as illustrated in FIG. 1B, is provided with a signal conversion unit 100 and a driving circuit unit 101. The signal conversion unit 100 converts an RGB color signal RGBi supplied from an external MPU (Microprocessor) or a video controller (not illustrated) into an RGBW color signal (Ro, Go, Bo, Wo) through addition of a white color signal to the RGB signal to output the RGBW color signal. Also, a detailed shape of the brightness sensor 106 is not specially limited, and an existing light quantity sensor may be used if it can detect the brightness in the surroundings. An output signal value of the brightness sensor 106 becomes large when the surroundings are bright and becomes small when the surroundings are dark.

The signal conversion unit 100 is provided with a white color signal generation unit 105 which includes a white color signal operation unit that receives an input of the RGB color signal and calculates an output level of the white color signal. The white color signal generation unit 105 is configured to receive a brightness sensor output signal L that indicates the brightness information of an external environment detected by the brightness sensor 106. The white color signal operation unit calculates an output level W of a white color signal W, that corresponds to a sub-pixel D_{W} for outputting a white light from the RGB color signal, that is, output levels R, G, and B (0≦R,G,B≦1) of a red color signal Ri, a green color signal Gi, and a blue color signal Bi.

Further, the white signal generation unit 105 corrects the output level W of the white color signal Wi that is calculated by the white signal operation unit based on the brightness sensor output signal L input from the brightness sensor 106. Specifically, since the liquid crystal device 107 according to this embodiment is a reflective liquid crystal device, a brighter display is necessary when the external environment is dark, and a more vivid color display (display having high color purity) is necessary when the external environment is bright. Accordingly, in order to implement this, as illustrated in FIG. 2, the output level W of the white color signal Wi is corrected in a manner that when the brightness sensor output signal L is low (if the external environment is dark), the output level W of the white color signal Wi becomes high (the luminance of the output light from the sub-pixel D_{W} for outputting a white light becomes high), while when the brightness sensor output signal L is high (if the external environment is bright), the output level W of a white light signal Wi becomes low (the luminance of the output light from the sub-pixel D_{W} for outputting a white light becomes low).

The relationship between the brightness sensor output signal L and the output level W of the white color signal Wi, as indicated by a solid line in FIG. 2, may be a straight line relationship having a constant slope, a straight line relationship having a slope that is changed in the midway, or a curved line relationship as indicated by a dashed line in FIG. 2. Also, the white color signal generation unit 105 may adopt a method that refers to a lookup table that is prepared to indicate correction values of the brightness sensor output signal L and the output level W of the white color signal Wi as a means for performing an actual correction, a method that uses a calculation formula for calculating a correction value of the output level W of the white color signal Wi based on the brightness sensor output signal L, or an arbitrary method.

The driving circuit unit 101 includes at least a data signal generation unit that converts the RGBW color signal supplied from the signal conversion unit 100 into data signals (grayscale data) Sr, Sg, Sb, and Sw of sub-pixels of the corresponding colors and a signal output unit that outputs the data signals to the sub-pixels D_{R}, D_{G}, D_{B}, and D_{W} in synchronization with selection operations of the respective sub-pixels. Also, the driving circuit unit 101 converts the RGBW color signal supplied from the signal conversion unit 100 into data signals (grayscale data) Sr, Sg, Sb, and Sw of sub-pixels of the corresponding colors, and outputs the data signals to the respective sub-pixels of the corresponding colors.

The liquid crystal device 107 having the above-described configuration according to this embodiment receives an RGB color signal RGBi that is supplied from an MPU or a video controller (not illustrated) to the driving IC 110 and the output signal L from the brightness sensor 106, and inputs these signals to the driving IC 110. The driving IC 110 inputs the input RGB color signal RGBi and the brightness sensor output signal L to the signal conversion unit 100.

The signal conversion unit 100 derives output levels R, G, and B (0≦R,G,B≦1) of the input RGB color signal through the white color signal operation unit of the white color signal generation unit 105 that is built therein. Then, the signal conversion unit 100 calculates the output level W of the white color signal by an operation using the obtained output levels R, G, and B and an arbitrary operation equation, performs correction of the output level W of the white color signal based on the brightness sensor output signal L, and outputs a white color signal Wo of the obtained output level to the driving circuit unit 101. Also, the signal conversion unit 100 outputs the RGBW color signal composed of color signals Ro, Go, and Bo, which are color signals Ri, Gi, and Bi input from the outside, to the driving circuit unit 101.

The driving circuit unit 101 converts the input RGBW color signal into the data signals Sr, Sg, Sb, and Sw for sub-pixels of the corresponding colors to output the converted data signals, and by the input of such data signals, the sub-pixels DR, DG, DB, and DW light up according to the output levels of the data signals, resulting in that the pixel P is displayed with a mixed color of the sub-pixels.

FIG. 3 illustrates an example of a display state of respective sub-pixels, and FIG. 4 illustrates a display state of a general liquid crystal device in the related art for comparison.

In the general liquid crystal device in the related art, as illustrated in FIG. 4, regardless of a dark place and a bright place, the sub-pixel D_{R} for outputting a red light lights up in the case of displaying a red color, the sub-pixel D_{G} for outputting a green light lights up in the case of displaying a green color, and the sub-pixel D_{B} for outputting a blue light lights up in the case of displaying a blue color. As described above, since the lighting states of the respective sub-pixels are the same in a dark place and in a bright place, the display becomes dark in a dark place having weak external light, and thus the visibility is lowered.

By contrast, in the liquid crystal device 107 according to this embodiment, as illustrated in FIG. 3, in a dark place, the sub-pixel D_{R} for outputting a red light and the sub-pixel D_{W} for outputting a white light light up in the case of displaying a red color, the sub-pixel D_{G} for outputting a green light and the sub-pixel D_{W} for outputting a white light light up in the case of displaying a green color, and the sub-pixel D_{B} for outputting a blue light and the sub-pixel D_{W} for outputting a white light light up in the case of displaying a blue color. On the other hand, in a bright place, the sub-pixel D_{R} for outputting a red light lights up in the case of displaying a red color, the sub-pixel D_{G} for outputting a green light lights up in the case of displaying a green color, and the sub-pixel D_{B} for outputting a blue light lights up in the case of displaying a blue color. In any case as described above, the sub-pixel D_{W} for outputting a white light does not light up.

In this case, for simplicity in explanation, although it is exemplified that the sub-pixel D_{W} for outputting a white light lights up in the dark place and does not light up in the bright place, in practice, the luminance of the light output from the sub-pixel D_{W} for outputting a white light is continuously (in a straight line or in a curved line) changed according to the brightness sensor output signal value as illustrated in FIG. 2.

According to the liquid crystal device 107 according to this embodiment as described above, the signal conversion unit 100 of the driving IC 110 controls the output level W of the white color signal Wi that is supplied to the sub-pixel D_{W} for outputting a white light based on the brightness sensor output signal L input from the brightness sensor 106. Accordingly, in the case of using the liquid crystal device 107 in a bright place, the luminance of the output light from the sub-pixel D_{W} for outputting a white light is lowered, while in the case of using the liquid crystal device 107 in a dark place, the luminance of the output light from the sub-pixel D_{W} for outputting a white light is heightened. In this case, in the bright place, the display brightness is lowered, but the ratio of the red light, green light, and blue light forming part of the whole output lights is relative increased to improve the color purity. Also, in the dark place, the ratio of the white light forming part of the whole output lights is relative increased, and thus the brightness is improved while the color purity is lowered. By doing this, a liquid crystal device can be realized, which can perform a bright display or a vivid color display in accordance with the brightness of the external environment.

In the above-described embodiment, the signal conversion unit 100 having the white color signal operation unit is built in the driving IC 110. However, the driving control system in an electro-optical apparatus according to the application is not limited to the above-described configuration, and, for example, a configuration illustrated in FIGS. 5A and 5B may be applied.

FIG. 5A is a schematic diagram illustrating a first modified example of the liquid crystal device according to the first embodiment. A liquid crystal device 108 according to the first modified example as illustrated in FIG. 5A includes a pixel P composed of four sub-pixels D_{R}, D_{G}, D_{B}, and D_{W}, a signal conversion unit 100A, and a driving circuit unit 101A. That is, the signal conversion unit 100 and the driving circuit unit 101, which are united in the driving IC 110 in the above-described embodiment, are replaced by the signal conversion unit 100A and the driving circuit unit 101A, which separately provided. By installing the signal conversion unit 100A as a separate circuit, the configuration according to the present application can be realized without changing the configuration of the driving circuit unit 101A or the pixel P in the related art configuration.

FIG. 5B is a schematic diagram illustrating a second modified example of the liquid crystal device according to the first embodiment. A liquid crystal device 109 according to the second modified example as illustrated in FIG. 5B includes an image processing unit 102 that receives a different type image signal Video such as a YUV signal or an NTSC composite signal and outputs an RGBW color signal, and a driving circuit unit 101A.

The image processing unit 102 is provided with an image conversion unit that performs a conversion of an image signal and the signal conversion unit 100 according to the first embodiment. In other words, the image processing unit 102 is a video controller provided with the signal conversion unit 100. The image processing unit 102 converts the input image signal Video into an RGB color signal in the image conversion unit, and inputs this RGB color signal to the signal conversion unit 100 to converts the RGB color signal into an RGBW color signal. The image processing unit 102 outputs the RGBW color signal to the driving circuit unit 101A.

Since the above-described configuration according to the second modified example becomes the liquid crystal device having a built-in video controller, generality in mounting the liquid crystal device on an electronic appliance is heightened. Also, the configuration according to the present application can be realized without changing the configuration of the driving circuit unit 101A and the pixel P in the related art.

In this case, although it is exemplified that the liquid crystal device is provided with the brightness sensor 106, the liquid crystal device may not be provided with the brightness sensor 106, and it is sufficient if the liquid crystal device is configured to receive an input of an output signal from an externally installed brightness sensor. By this configuration, the liquid crystal device itself has a compact configuration.

### Second Embodiment

Hereinafter, a second embodiment will be described with reference to FIG. 6.

A liquid crystal display according to this embodiment is an example of a reflective liquid crystal device that uses three sub-pixels having low color purity as sub-pixels for controlling luminance and color purity.

In this embodiment, the basic configuration of the liquid crystal device is equal to that according to the first embodiment, but only a configuration of sub-pixels in a pixel is different from that according to the first embodiment. Accordingly, hereinafter, only the configuration of sub-pixels in a pixel will be described using FIG. 6.

The liquid crystal device according to this embodiment, as illustrated in FIG. 6, includes a pixel P1 that is composed of six sub-pixels in all, which includes a sub-pixel D_{R1} for outputting a red light, a sub-pixel D_{G1} for outputting a green light, a sub-pixel D_{B1} for outputting a blue light, a sub-pixel D_{R2} for outputting a low-color purity red light (a sub-pixel for controlling luminance and color purity), a sub-pixel D_{G2} for outputting a low-color purity green light (a sub-pixel for controlling luminance and color purity), and a sub-pixel D_{B2} for outputting a low-color purity blue light (a sub-pixel for controlling luminance and color purity). The sub-pixel D_{R2} for outputting a low-color purity red light outputs a red light having a color purity that is lower than that of a red light output from the sub-pixel D_{R1} for outputting a red light. In the same manner, the sub-pixel D_{G2} for outputting a low-color purity green light outputs a green light having a color purity that is lower than that of a green light output from the sub-pixel D_{G1} for outputting a green light, and the sub-pixel D_{B2} for outputting a low-color purity blue light outputs a blue light having a color purity that is lower than that of a blue light output from the sub-pixel D_{B1} for outputting a blue light. The difference in color purity between the sub-pixels can be realized by changing a color-existing layer of color filters to be described later.

In the liquid crystal device according to this embodiment, as illustrated in FIG. 6, in a dark place, the sub-pixel D_{R1} for outputting the red light and the sub-pixel D_{R2} for outputting a low-color purity red light light up in the case of displaying a red color, the sub-pixel D_{G} for outputting a green light and the sub-pixel D_{G} for outputting a low-color purity green light light up in the case of displaying a green color, and the sub-pixel D_{B} for outputting a blue light and the sub-pixel D_{B2} for outputting a low-color purity blue light light up in the case of displaying a blue color. On the other hand, in a bright place, the sub-pixel D_{R} for outputting a red light lights up in the case of displaying a red color, the sub-pixel D_{G} for outputting a green light lights up in the case of displaying a green color, and the sub-pixel D_{B} for outputting a blue light lights up in the case of displaying a blue color. In any case as described above, the respective sub-pixels D_{R2}, D_{G2}, and D_{B2} for outputting low-color purity color lights do not light up. In this case, for simplicity in explanation, although it is exemplified that the respective sub-pixels D_{R2}, D_{G2}, and D_{B2} for outputting low-color purity color lights light up in the dark place, and do not light up in the bright place, in practice, the luminance of the lights output from the respective sub-pixels D_{R2}, D_{G2}, and D_{B2} for outputting low-color purity color lights is continuously (in a straight line or in a curved line) changed according to a brightness sensor output signal value such as the sub-pixel D_{W} for outputting a white light according to the first embodiment.

Even in this embodiment, the same effect as in the first embodiment can be obtained, which can realize a liquid crystal device that can perform a bright display or a vivid color display according to the brightness of the external environment. Also, in the first embodiment, by using the sub-pixel D_{W} for outputting a white light as the sub-pixel for controlling luminance and color purity, the liquid crystal device having superior display brightness especially in the dark place is obtained. On the other hand, in this embodiment, by configuring one pixel with 6 sub-pixels in all using the sub-pixels D_{R2}, D_{G2}, and D_{B2} for outputting low-color purity color lights as sub-pixels for controlling luminance and color purity, a liquid crystal device having superior color reproduction can be realized.

In this embodiment, although the sub-pixels D_{R2}, D_{G2}, and D_{B2} for outputting three low-color purity color lights are used as sub-pixels for controlling luminance and color purity, it is not necessary to surely use the sub-pixels D_{R2}, D_{G2}, and D_{B2} for outputting three low-color purity color lights. For example, in consideration of the fact that a green light has the highest visual sensitivity to human eyes, one pixel may be configured by four sub-pixels in all through the use of only the sub-pixel D_{G2} for outputting a low-color purity green light as the sub-pixel for controlling luminance and color purity. Even in this case, the color reproduction can be improved in comparison to a case where one pixel is configured by three color sub-pixels.

### Third Embodiment

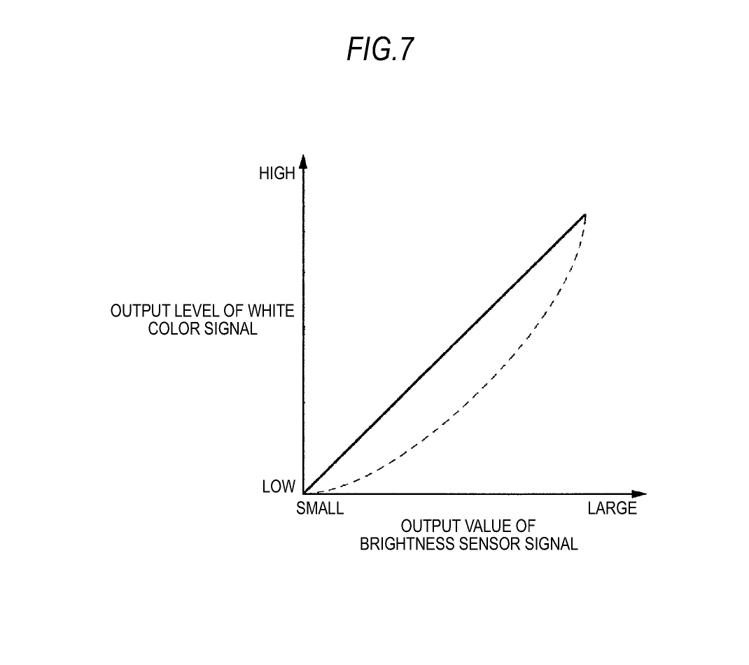

Hereinafter, a third embodiment will be described with reference to FIG. 7.

A liquid crystal display according to this embodiment is an example of a transmissive liquid crystal device that uses a sub-pixel for outputting a white light as a sub-pixel for controlling luminance and color purity.

In this embodiment, the basic configuration of the liquid crystal device is equal to that according to the first embodiment except for the difference between the reflective type and the transmissive type, and only a control direction of the sub-pixel for outputting a white light against the brightness of the external environment is different from that according to the first embodiment.

Accordingly, hereinafter, only this difference will be described using FIG. 7

Since the liquid crystal device according to the first embodiment is a reflective liquid crystal device, a bright display is necessary when the external environment is dark, and a vivid color display (display having high color impurity) is necessary when the external environment is bright. By contrast, since the liquid crystal device according to this embodiment is a transmissive liquid crystal device, on the contrary to the reflective liquid crystal device, a bright display is necessary to secure the visibility of display when the external environment is bright, and a vivid color display (display having high color impurity) is necessary when the external environment is dark since the visibility can be secured even when the external environment is dark, that is, is not so bright.

Accordingly, as illustrated in FIG. 7, the output level W of the white color signal Wi is corrected in a manner that when the brightness sensor output signal L is low (if the external environment is dark), the output level W of the white color signal Wi becomes low (the luminance of the output light from the sub-pixel D_{W} for outputting a white light becomes low), while when the brightness sensor output signal L is high (if the external environment is bright), the output level W of the white color signal Wi becomes high (the luminance of the output light from the sub-pixel D_{W} for outputting a white light becomes high).

The relationship between the brightness sensor output signal L and the output level W of the white color signal Wi, as indicated by a solid line in FIG. 7, may be a straight line relationship having a constant slope, a straight line relationship having a slope that is changed in the midway, or a curved line relationship as indicated by a dashed line in FIG. 7. Also, the white color signal generation unit 105 may adopt the same method as in the first embodiment as the means for actually performing the correction.

Even in the transmissive liquid crystal device according to this embodiment, the same effect as in the first and second embodiments is obtained, in which a liquid crystal device, which can perform a bright display or a vivid color display in accordance with the brightness of the external environment, can be realized.

Whole Configuration of Liquid Crystal Device

Hereinafter, the whole configuration of the liquid crystal device according to the above-described embodiments will be described.

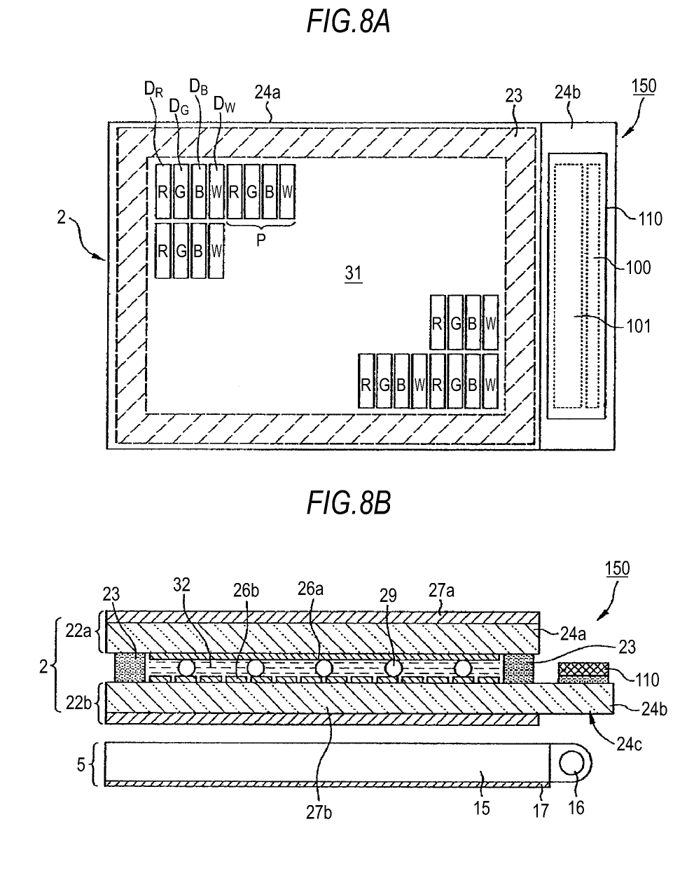

FIG. 8A is a plan view of a liquid crystal device and FIG. 8B is a cross-sectional view of FIG. 8A.

A liquid crystal display 150 has a liquid crystal panel 2 that is a display unit, and in the case of a reflective liquid crystal device according to the first or second embodiment, the display becomes possible using only the liquid crystal panel. Also, in the case of a transmissive liquid crystal device according to the third embodiment, as illustrated in FIG. 8B, a backlight (an illumination device) 5 installed on a rear side of the liquid crystal panel 2 (bottom side as illustrated) is necessary.

The liquid crystal panel 2 is obtained by integrally bonding a first substrate 22a and a second substrate 22b, between which liquid crystals 32 are interposed, by a sealant 23 that is installed on edge portions of the two substrates in the form of a ring. The first substrate 22a that serves as a display surface of the liquid crystal panel 2 in this embodiment has a configuration in which a liquid crystal alignment control layer that is composed of a permissible common electrode 26a, an alignment layer (not illustrated), and the like, is formed on a surface on the liquid crystal layer side of the substrate main body 24a that is a transparent substrate. The second substrate 22b that is arranged on an opposite side to the display surface (the illustrated bottom surface side) has a configuration in which the liquid crystal alignment control layer that is composed of a pixel electrode 26b, an alignment layer (not illustrated), and the like, is formed on a surface on the liquid crystal layer side of the substrate main body 24b that is a transparent substrate. Between the two substrates 22a and 22b that form the liquid crystal panel 2, granule-shaped spacers 29 for uniformly maintaining a distance (cell gap) between the substrates 22a and 22b are arranged to be distributed.

Also, color filters are installed on any one of the first substrate 22a and the second substrate 22b. In the case of using a sub-pixel for outputting a white light as the sub-pixel for controlling luminance and color purity as in the first and third embodiments, a color-existing layer of the color filter is not necessary in a position that corresponds to the sub-pixel for outputting a white light. In the case of using a sub-pixel for outputting a low-color purity color light as the sub-pixel for controlling luminance and color purity as in the second embodiment, it is necessary to change a color purity, that is, color density, of the color-existing layer of the color filter in a position that corresponds to the sub-pixel for outputting a general color light and in a position that corresponds to the sub-pixel for outputting a low-color purity color light.

In the case of a reflective liquid crystal device, a reflection layer for reflecting light incident from the side of the first substrate 22a is necessary on the second substrate 22b that is a substrate on the opposite side to the visual recognition side. The reflection layer may be formed of a metal having high reflexibility such as aluminum on the surface of the liquid crystal layer side of the substrate main body 24b, or may be attached to the surface on the opposite side to the liquid crystal layer of the substrate main body 24b as a built-out reflection plate. On the other hand, a pixel electrode 26b may be formed of a metal having high reflexibility such as aluminum on the surface of the liquid crystal layer side of the substrate main body 24b, and this pixel electrode 26b may also serve as the reflection layer.

A backlight 5 used in the transmissive liquid crystal device includes a light guide plate 15 made of a transparent resin material, a light source 16 installed on an end surface of one side of the light guide plate 15, and a reflection plate 17 installed on a rear surface side (opposite side to the liquid crystal panel 2) of the light guide plate 15. The light source 16 is composed of an Light-Emitting Diodes (LED) or a cold-cathode tube. A light output from the light source 16 is introduced into the inside of the light guide plate 15 from the side end surface of the light guide plate 15, the light is reflected by the reflection plate 17, and the reflected light is output to the side of the liquid crystal panel 2 as an illumination light.

The liquid crystal panel 2 may be any one of a passive matrix type and an active matrix type, and diverse known alignment types, such as TN type, VAN type, STN type, ferroelectric type, semi-ferroelectric type, and the like, may be adopted as alignment types of the liquid crystals.

On the second substrate 22b of the liquid crystal panel 2, a projection portion 24c that projects to the circumferential side of the first substrate 22a is provided. This projection portion 24c is used as a terminal mounting area. An interconnection pattern (not illustrated) is formed on the projection portion 24c, and the pixel electrode 26b of the second substrate 22b is electrically connected to the interconnection pattern of the projection portion 24c through a switching element (not illustrated) and the interconnection pattern. Also, the common electrode 26a of the first electrode 22a is electrically connected to the interconnection pattern of the projection portion 24c through an interconnection pattern and a conductive material (not illustrated). Also, with respect to the interconnection pattern of the projection portion 24c, a driving IC 110 for electrically driving the liquid crystal panel 2 is mounted. The mount type of the driving IC 110 may be COG mount, FPC mount, or the like.

As illustrated in FIG. 8A, on an image display unit 31 that is formed on the inner side surrounded by the sealant 23 of the liquid crystal panel 2, pixels P composed of four-color sub-pixels D_{R}, D_{G}, D_{B}, and D_{W} are arranged in the form of a matrix. As described above, the colors of the sub-pixels D_{R}, D_{G}, D_{B}, and D_{W} are determined by color filters installed corresponding to the respective sub-pixels. The sub-pixel D_{W} for outputting a white light may have a configuration in which no color filter is installed or a transparent color filter is installed.

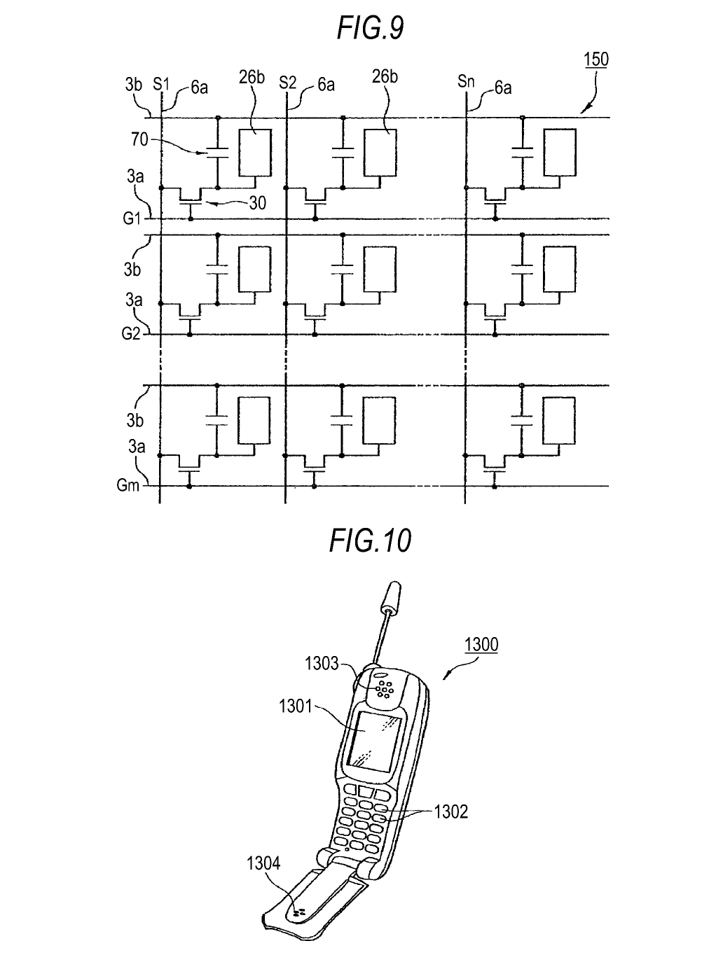

Here, FIG. 9 is an equivalent circuit diagram of the image display unit 31 in which the sub-pixels D_{R}, D_{G}, D_{B}, and D_{W} are arranged. On the image display unit 31 of the liquid crystal panel 2, data lines 6a and scanning lines 3a are arranged in the form of a lattice, and in the neighborhood of the cross points of the data lines 6a and the scanning lines 3a, the sub-pixels D_{R}, D_{G}, D_{B}, and D_{W} that are image display units are arranged. Accordingly, the respective sub-pixels D_{R}, D_{G}, D_{B}, and D_{W} that constitute the pixel P are electrically connected to the driving IC 110 through the data lines 6a and the scanning lines 3a.

On the plural sub-pixels D_{R}, D_{G}, D_{B}, and D_{W} arranged in the form of a matrix, respective pixel electrodes 26b are installed. In the neighborhood of the pixel electrode 26b, a TFT 30 that is a switching element for performing turn-on control of the pixel electrode 26b is formed. The source of the TFT 30 is electrically connected to the data line 6a. To the respective data lines 6a, data signals Si to Sn (data signals Sr, Sg, SB, and Sw illustrated in FIGS. 1A and 1B) are applied. The gate of the TFT 30 is electrically connected to the scanning line 3a. To the scanning lines 3a, scanning signals G1 to Gm, which are pulse signals at a predetermined timing, are applied. The drain of the TFT 30 is electrically connected to the pixel electrode 26b. If the TFT 30, which is a switching element, is in a turned-on state for a predetermined period by the scanning signals G1 to Gm applied from the scanning lines 3a, the data signals Si to Sn applied from the data lines 6a are recorded on the liquid crystals of the respective pixels at a predetermined timing.

The data signals S1 to Sn of a predetermined level, which are recorded on the liquid crystals, are maintained for a predetermined period by the liquid crystal capacitance formed between the pixel electrode 26b and the common electrode to be described later. Also, in order to prevent the maintained data signals Si to Sn from leaking, accumulated capacitance 70 is formed between the pixel electrode 26b and a capacitance line 3b, and is arranged in parallel to the liquid crystal capacitance. Also, if a voltage signal is applied to the liquid crystals as described above, the alignment state of the liquid crystals is changed by the applied voltage level. Accordingly, light incident to the liquid crystals is modulated to make a grayscale display possible.

The liquid crystal device 150 having the above-described configuration can perform the display as the data signals Sr, Sg, Sb, and Sw are applied to the four-color sub-pixels DR, DG, DB, and DW from the driving IC 110. Also, since the liquid crystal device 150 is configured to control the output level W of the white color signal Wi that is supplied to the sub-pixel D_{W} for outputting a white light based on the brightness sensor output signal L, a liquid crystal device that can perform a bright display or a vivid color display according to the brightness of the external environment can be realized.

Electronic Appliance

FIG. 10 is a perspective view of a portable phone that is an example of an electronic appliance according to the embodiment for the application. A portable terminal 1300 illustrated in FIG. 10 includes plural operation buttons 1302, a receiver 1303, a sender 1304, and a liquid crystal display unit 1301 composed of the liquid crystal device according to the above-described embodiments. The portable phone may have a configuration that converts an image signal transmitted to the liquid crystal display unit 1301 into an RGBW color signal that includes a white color signal through a video controller or an MPU that includes the white color signal operation unit.

In this case, the electronic appliance provided with an electro-optical device according to the present application is not limited to that as described above, and may be, for example, an appliance including a digital camera, a personal computer, a television receiver, a portable television receiver, a video tape recorder of viewfinder type or of monitor direct viewing type, a PDA, a portable game machine, a pager, an electronic pocketbook, an electronic calculator, a timepiece, a word processor, a workstation, a video phone, a POS terminal, a device with a touch panel, or the like.

The technical scope of the present application is not limited to the above-described embodiments, but diverse modifications can be made without departing from the scope of the application. For example, although a reflective liquid crystal device is exemplified in the first and second embodiments, and a transmissive liquid crystal device is exemplified in the third embodiment, the present application may be applied to a semi-transmissive reflective liquid crystal device having both a reflective display mode and a transmissive display mode. However, as described above, since the control directions of the sub-pixels for controlling luminance and color purity are opposite to each other in the reflective display mode and in the transmissive display mode, it is necessary to install both a sub-pixel for controlling luminance and color purity for reflective display and a sub-pixel for controlling luminance and color purity for transmissive display in one pixel. Also, the arrangement of the sub-pixels is changeable in addition to those in the above-described embodiments. Also, although it is exemplified that the pixels for outputting specified color lights are a sub-pixel for outputting a red light, a sub-pixel for outputting a green light, and a sub-pixel for outputting a blue light, sub-pixels for outputting color lights except for the red light, green light, and the blue light may be used, or four or more sub-pixels for outputting four or more color lights may be used. In addition, the detailed configuration of various kinds of configurable elements that configure the liquid crystal device can be changed appropriately.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

1. A liquid crystal device comprising:
a pixel for outputting a specified color light, which is provided with liquid crystals and an electrode for driving the liquid crystals and outputs light of the specified color;
a pixel for controlling luminance and color purity, which outputs a control light for controlling the luminance and the color purity of the output light of the specified color; and
a driving unit driving the pixel for outputting a specified color light, and the pixel for controlling luminance and color purity based on brightness information that indicates the brightness of an external environmental light.

2. The liquid crystal device according to claim 1, wherein the pixel for outputting a specified color light includes a sub-pixel for outputting a red light, a sub-pixel for outputting a green light, and a sub-pixel for outputting a blue light, and the pixel for controlling luminance and color purity includes a pixel for controlling luminance and color purity, which outputs the control light for controlling the luminance and the color purity of at least one output light of the red color, the green color, and the blue color.

3. The liquid crystal device according to claim 1, wherein a reflective layer that reflects the external environmental light is provided in the pixel for outputting a specified color light and in the pixel for controlling luminance and color purity, and
the driving unit drives the pixel for controlling luminance and color purity so that the luminance of the control light from the pixel for controlling luminance and color purity becomes higher when the external environmental light is dark rather than bright.

4. The liquid crystal device according to claim 1, wherein an illumination device that outputs illumination light is provided in the pixel for outputting a specified color light and in the pixel for controlling luminance and color purity, and
the driving unit drives the pixel for controlling luminance and color purity so that luminance of the control light from the pixel for controlling luminance and color purity becomes lower when the external environmental light is dark rather than bright.

5. The liquid crystal device according to claim 1, wherein a sensor that detects the brightness of the external environmental light is provided, and
the driving unit drives the pixel for controlling luminance and color purity based on the brightness information detected by the sensor.

6. The liquid crystal device according to claim 1, wherein the pixel for controlling luminance and color purity is composed of a pixel for outputting a white light.

7. The liquid crystal device according to claim 1, wherein the pixel for controlling luminance and color purity includes at least one of a sub-pixel for outputting a low-color purity red light, which outputs a red light having a color purity that is lower than that of the red light that is output from the sub-pixel for outputting a red light, a sub-pixel for outputting a low-color purity green light, which outputs a green light having a color purity that is lower than that of the green light that is output from the sub-pixel for outputting a green light, and a sub-pixel for outputting a low-color purity blue light, which outputs a blue light having a color purity that is lower than that of the blue light that is output from the sub-pixel for outputting a blue light.

8. A method of driving a liquid crystal device including
a pixel for outputting a specified color light, which is provided with liquid crystals and an electrode for driving the liquid crystals and outputs light of the specified color;
a pixel for controlling luminance and color purity, which outputs a control light for controlling the luminance and the color purity of the output light of the specified color; and
a driving unit driving the pixel for outputting a specified color light, and the pixel for controlling luminance and color purity based on brightness information that indicates the brightness of an external environmental light, the method comprising the steps of:
generating a driving signal that is supplied to a pixel for outputting a specified color light based on an image signal; and
generating a driving signal that is supplied to a pixel for controlling luminance and color purity based on brightness information of the image signal and an external environmental light.

9. An electronic appliance provided with a liquid crystal device according to claim 1.
